(19) United States
(12) Patent Application Publication
(10) Pub. No.: US 2016/0102770 A1
(43) Pub. Date: Apr. 14, 2016

(54) VALVE STRUCTURE

(71) Applicant: TOYOTA JIDOSHA KABUSHIKI KAISHA, Toyota-shi (JP)

(72) Inventors: Kazutoshi WAKATSUKI, Toyota-shi (JP); Nakaya TAKAGAKI, Toyota-shi (JP); Hideyuki KOMITSU, Toyota-shi (JP)

(21) Appl. No.: 14/857,300

(22) Filed: Sep. 17, 2015

(30) Foreign Application Priority Data
Oct. 9, 2014 (JP) 2014-208041

(51) Int. Cl. F16K 15/03; F16K 1/36; F16K 1/18

(52) U.S. Cl. CPC F16K 15/033; F16K 1/18; F16K 1/36

(57) ABSTRACT

A valve member 38 of a valve structure 32 is rotatably supported from an outer tube 34 by a rotation shaft 40. The rotation shaft 40 is fixed to the valve member 38 at a position inside a tangent to the outer periphery of the valve member 38 and avoiding the center point. A return spring 52 is a tension spring that causes tension force to constantly act on a link arm 54 to generate a rotation force toward the closing direction of the valve member 38.

### CROSS-REFERENCE TO RELATED APPLICATION

This application is based upon and claims the benefit of priority of the prior Japanese Patent Application No. 2014-208041, filed on Oct. 9, 2014, the entire contents of which are incorporated herein by reference.

### FIELD

The embodiments discussed herein are related to a valve structure.

### BACKGROUND

As a valve structure provided to an exhaust pipe, Japanese Utility Model Laid-Open (JP-U) No. H03-51124, for example, describes a structure provided to an outer shell of a muffler in which, when high pressure exhaust gas acts on a valve body being biased against an opening by a spring, the valve body rotates about a shaft, and opens the opening.

For example, there is a description in Japanese Patent Application Laid-Open (JP-A) No. H09-303143 of a structure in which a butterfly valve is fixed to a valve shaft provided so as to be rotatable to a casing. In JP-A No. H09-303143, the butterfly valve is constantly biased in the closing direction by the recovery force of a return spring wound around the outer periphery of the valve shaft. The structure of JP-A No. H09-303143 is such that the spring force of a compression spring acts on a link fixed to the valve shaft. When the butterfly valve is open, spring force of the compression spring acts in the butterfly valve closing direction up to the point that a coupling pin of the link reaches a turnover position. When the coupling pin passes the turnover position, the spring force of the compression spring acts in the butterfly valve opening direction.

### RELATED PATENT DOCUMENTS

JP-U No. H03-51124

JP-A No. H09-303143

As a valve structure for opening and closing the inside of an exhaust pipe by rotating (swinging) a valve member, there is a structure in which a valve member is biased to a closed position by employing a spring or the like. When a portion of spring force acts as a large load on a shaft of a valve member, the friction against a shaft bearing portion becomes large, and the valve member becomes difficult to close. If the spring force in the closing direction is set large in order to reliably close the valve member (maintain the closed position), it becomes difficult to secure a large opening angle.

Moreover, although a structure is conceivable in which a link is attached to a rotation shaft, and spring force acts on this link, in a structure in which a torsion spring is wound around a rotation shaft, it is difficult to secure an effective length for the link.

In consideration of the above circumstances, the present invention addresses obtaining a valve structure that secures a large opening angle of the valve member by reducing the friction between rotation shaft and shaft bearing by reducing the biasing force of a biasing member that biases a valve member in the closing direction.

### SUMMARY

In a first aspect, a valve member is provided at an exhaust pipe and rotates from a closed position closing off the exhaust pipe to an open position opening the exhaust pipe upon being contacted by exhaust gas, a rotation shaft is fixed to the valve member at a position, when viewing the valve member along an exhaust gas flow direction, inside a tangent to an outer periphery of the valve member and avoiding a center point of the valve member, and is attached to the exhaust pipe so as to be capable of rotating, a link member is fixed to the rotation shaft and includes an action point at a position distanced from the rotation shaft in the flow direction, and a tension spring is provided at the exhaust pipe and causes tension force to constantly act on the action point to generate a rotation force toward a closing direction of the valve member.

In this valve structure, the valve member rotates with the rotation shaft as the center of rotation, and opens and closes the inside of the exhaust pipe.

Tension force of the tension spring acts on the action point of the link member fixed to the rotation shaft. A portion of this tension force acts on the rotation shaft as rotation force toward the valve member closing direction. Namely, the valve member receives rotation force toward the closing direction from the tension force of the tension spring. When the force from the exhaust gas acting on the valve member toward the opening direction becomes large, the valve member is rotated in the opening direction against the rotation force from the tension force of the tension spring in the closing direction.

The rotation shaft (center of rotation) is at a position that is inside a tangent to the outer periphery of the valve member and avoids the center point of the valve member. Namely, forces from the exhaust gas acting on the valve member act as rotation forces in opposite directions to each other on a large area portion (a face including the center point, a pressure bearing face) and on a small area portion (a face not including the center point) that have the rotation shaft as the boundary therebetween. A portion of the force from the exhaust gas acting on the large area portion of the valve member is canceled out by the force acting on the small area portion. The effective force from the exhaust gas acting on the valve member in the opening direction is accordingly smaller than in structures in which the rotation shaft is provided at a position of the tangent to the outer periphery of the valve member.

In this manner, the force from the exhaust gas acting on the valve member in the opening direction is smaller, and therefore even if a small tension force is set for the tension spring, the valve member can still be reliably returned to the closed position, or the closed position can be maintained, in a state in which there is a weak flow of exhaust gas.

By making the tension force of the tension spring weaker, the component of the tension force from the tension spring on the rotation shaft in the direction toward the center of rotation also becomes smaller. Frictional force acts between the rotation shaft and shaft bearings, however this frictional force is also smaller. The frictional force being smaller enables a large rotation angle to be set for the open position of the valve member.

In addition, in the first aspect, it is the tension spring that is the member that causes tension force, generating rotation force toward the valve member closing direction to constantly act on the action point. This member, accordingly, gives a high degree of freedom in the shape of a link member in comparison to structures in which this member is configured by a torsion spring wound around a rotation shaft, for example. Setting the position of the action point of the link member a sufficient distance away from the rotation shaft enables the rotation moment acting on the rotation shaft to be made larger. This thereby enables the tension force of the tension spring to be set smaller, enabling the component of the tension force on the rotation shaft from the tension spring in the direction toward the center of rotation to be made smaller.

A second aspect is the first aspect in which a pressure bearing face including the center point of the valve member has a shape bulging toward a downstream side in the flow direction.

Thus, when the valve member is oriented in the open position, the surface pressure acting due to the flow of exhaust gas is higher, and the force that rotates the valve member toward the open position is also larger, on progression away from the rotation shaft.

A third aspect is the second aspect in which a curvature of the pressure bearing face, as viewed in cross-section taken along the flow direction, increases as a distance from the rotation shaft increases, or is constant.

If the curvature of the pressure bearing face, as viewed in cross-section taken along the flow direction, is shaped so as to decrease as the distance from the center of rotation increases, there is a concern that negative pressure might be generated when exhaust gas hits the pressure bearing face and flows along the pressure bearing face. As in the third aspect, by making the curvature of the pressure bearing face increase as the distance from the center of rotation increases, or constant, negative pressure can be suppressed from occurring, and so there is a large force rotating the valve member toward the open position.

### BRIEF DESCRIPTION OF DRAWINGS

FIG. 1 is a perspective view illustrating a valve structure of a first exemplary embodiment together with a portion of an exhaust pipe.

FIG. 2 is a face-on view illustrating a valve structure of the first exemplary embodiment together with a portion of an exhaust pipe, in a state as viewed from the upstream side of exhaust gas flow.

FIG. 3 is a plan view illustrating a valve structure of the first exemplary embodiment together with a portion of an exhaust pipe.

FIG. 4 is a side view illustrating a valve structure of the first exemplary embodiment together with a portion of an exhaust pipe.

FIG. 5 is a cross-section taken along line 5-5 of FIG. 2 and illustrating a closed state of a valve member in a valve structure of the first exemplary embodiment.

FIG. 6 is a cross-section at the same position as FIG. 5 and illustrating an open state of a valve member in a valve structure of the first exemplary embodiment.

FIG. 7A is a schematic diagram illustrating a relationship between a valve member and a rotation shaft of a first comparative example.

FIG. 7B is a schematic diagram illustrating a relationship between a valve member and a rotation shaft of the first exemplary embodiment.

FIG. 7C is a schematic diagram illustrating a relationship between a valve structure and a rotation shaft of a structure not of the present invention.

FIG. 8A is a schematic diagram illustrating a relationship between a valve member and a rotation shaft of a first comparative example.

FIG. 8B is a schematic diagram illustrating a relationship between a valve member and a rotation shaft of the first exemplary embodiment.

FIG. 8C is a schematic diagram illustrating a relationship between a valve structure and a rotation shaft of a structure not of the present invention.

FIG. 9A is an explanatory diagram illustrating a state with a tension force from a return spring acting on a valve member in a closed position in the first exemplary embodiment.

FIG. 9B is an explanatory diagram illustrating a state with a tension force from a return spring acting on a valve member in between a closed position and an open position in the first exemplary embodiment.

FIG. 9C is an explanatory diagram illustrating a state with a tension force from a return spring acting on a valve member in an open position in the first exemplary embodiment.

FIG. 10 is a graph qualitatively illustrating a relationship between rotation force acting on a valve member and opening angle of the valve member in the first exemplary embodiment.

FIG. 11 is a perspective view illustrating a valve structure of a second exemplary embodiment together with a portion of an exhaust pipe.

FIG. 12 is a cross-section illustrating a valve structure of the second exemplary embodiment with a valve member in a closed state.

FIG. 13 is a cross-section illustrating a valve structure of the second exemplary embodiment with a valve member in an open state.

FIG. 14A is a schematic diagram illustrating a valve structure of the second exemplary embodiment with a valve member in a closed state.

FIG. 14B is a schematic diagram illustrating a valve structure of the second exemplary embodiment with a valve member in an open state.

FIG. 15A is a schematic diagram illustrating a valve structure of a first modified example of the second exemplary embodiment with a valve member in a closed state.

FIG. 15B is a schematic diagram illustrating a valve structure of the first modified example of the second exemplary embodiment with a valve member in an open state.

FIG. 16A is a schematic diagram illustrating a valve structure of a second modified example of the second exemplary embodiment with a valve member in a closed state.

FIG. 16B is a schematic diagram illustrating a valve structure of the second modified example of the second exemplary embodiment with a valve member in an open state.

FIG. 17 is a face-on view illustrating a valve structure of a third exemplary embodiment together with a portion of an exhaust pipe, as viewed from the upstream side of exhaust gas flow.

FIG. 18 is a side view illustrating a valve structure of the third exemplary embodiment together with a portion of an exhaust pipe.

FIG. 19 is an explanatory diagram illustrating a state with a tension force from a return spring acting on a valve member in an open position in the third exemplary embodiment.

FIG. 20 is a graph qualitatively illustrating a relationship between rotation force acting on a valve member and opening angle of the valve member in the third exemplary embodiment.

FIG. 21 is a graph qualitatively illustrating a relationship between back pressure in an exhaust pipe and engine revolutions.

FIG. 22 is a graph qualitatively illustrating a relationship between sound pressure level in an exhaust pipe and engine revolutions.

FIG. 23 is a graph qualitatively illustrating a relationship between amplitude and frequency of a valve member and engine revolutions.

### DESCRIPTION OF EMBODIMENTS

Explanation follows regarding a valve structure of a first exemplary embodiment of the present invention, with reference to the drawings.

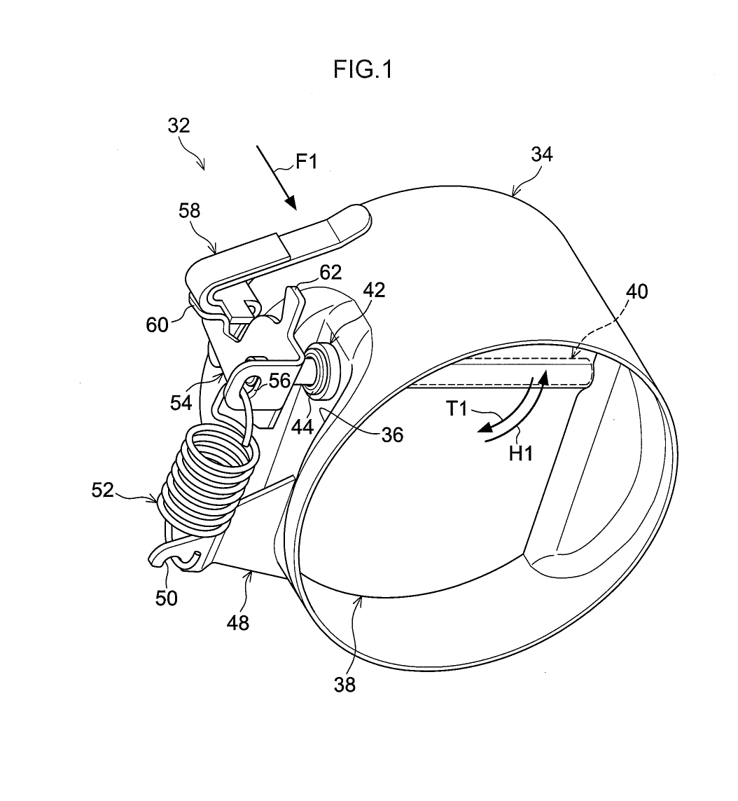

As illustrated in FIG. 1 to FIG. 3, a valve structure 32 of the first exemplary embodiment includes an outer tube 34. An exhaust pipe through which exhaust gas of an engine flows may be employed as the outer tube 34 and may, for example, be a branched portion (branched pipe) in cases in which an exhaust pipe branches partway along. Moreover, in a structure in which a muffler is provided in an exhaust pipe, the outer tube 34 may be a pipe provided inside a muffler. Any of the structures result in the valve structure 32 being provided in an exhaust pipe.

The direction of exhaust gas flow is illustrated by the arrow F1 in the drawings. Reference simply to “upstream” and “downstream” respectively indicates “upstream” and “downstream” in the direction of exhaust gas flow. In the present exemplary embodiment, the outer tube 34 has a substantially cylindrical shape overall. The flow direction of exhaust gas matches the axial direction of the outer tube 34.

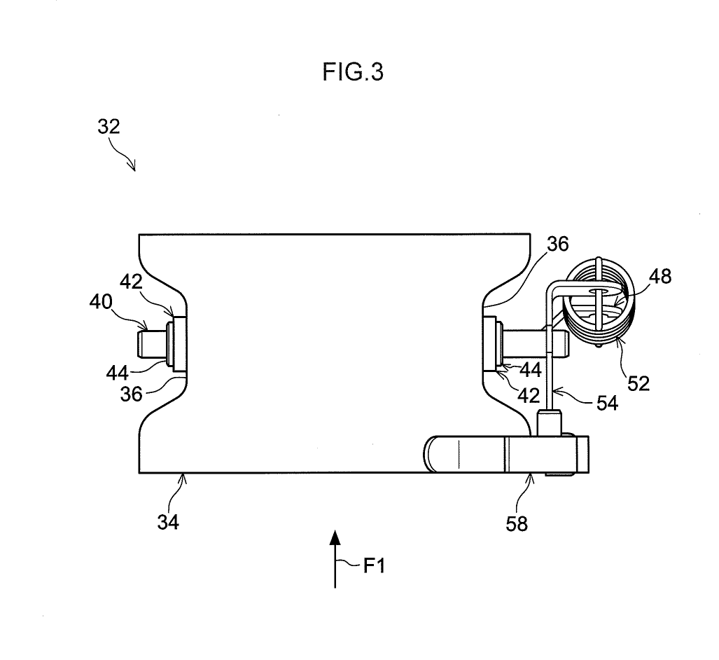

As illustrated in FIG. 1 and FIG. 3, in the outer tube 34 of the present exemplary embodiment, a pair of recesses 36 are formed at an axial direction portion of the outer tube 34 and at opposing positions in the circumferential direction, as indentations toward the inside (in a direction orthogonal to the axial direction). The outer tube 34 has a higher surface rigidity at the portions where the recesses 36 are formed than at portions where the recesses 36 are not formed.

The valve structure 32 includes a valve member 38 disposed inside the outer tube 34. As illustrated in FIG. 1, the valve member 38 is provided at a position where the recesses 36 are formed. The valve member 38 is a plate shaped member capable of closing off the inside of the outer tube 34 as viewed along the exhaust gas flow direction (the arrow F1 direction). Specifically, in the first exemplary embodiment the valve member 38 is flat plate shaped.

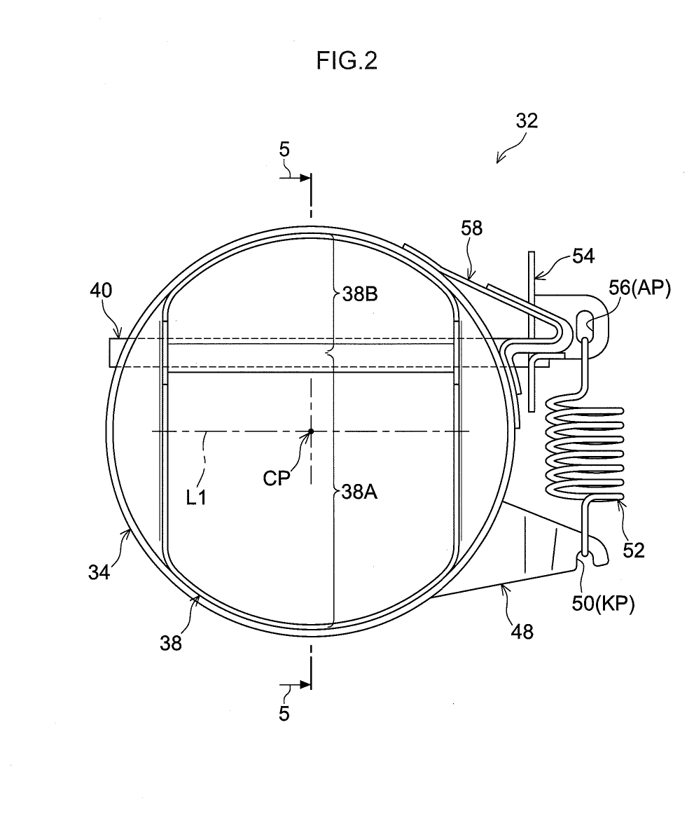

The shape of the valve member 38 as viewed face-on (as viewed along the arrow F1 direction) is, in the first exemplary embodiment, a substantially circular shape matching the internal shape of the outer tube 34, as can be seen from FIG. 2. However, portions of the valve member 38 corresponding to the recesses 36 are formed in straight lines, such that overall, the valve member 38 has an oval race track shape.

The center point CP of the valve member 38 illustrated in FIG. 2 is the point at the center of the surface area when the valve member 38 is viewed face-on (along the arrow F1 direction). Namely, when the valve member 38 is divided into two portions by an arbitrary straight line passing through the center point CP (for example the straight line L1), the surface areas of the two divided faces of the valve member 38 are the same as each other.

A rotation shaft 40 is fixed to the valve member 38. Both end portions of the rotation shaft 40 are supported by shaft bearings 42 attached to the outer tube 34, so as to be capable of rotating with respect to the outer tube 34. In the present exemplary embodiment, the shaft bearings 42 are provided at the recesses 36, and portions on both sides of the rotation shaft 40 pierce through the outer tube 34 at the recesses 36. Packing 44 is disposed between the pierced portions (through holes) in the outer tube 34, and the rotation shaft 40, maintaining an airtight seal between the inside and the outside of the outer tube 34.

The position of the rotation shaft 40 is to the inside of a tangent to the outer periphery of the valve member 38, and is a position avoiding the center point CP of the valve member 38. Thus, as can be seen from FIG. 2, as viewed face-on (along the arrow F1 direction), the valve member 38 is divided into a large area portion 38A including the center point CP, and a small area portion 38B not including the center.

A bracket 48 is fixed to the outer periphery of the outer tube 34. An anchor portion 50 is formed to a leading end of the bracket 48. One end of a return spring 52 (anchor point KP) is anchored to the anchor portion 50. In the first exemplary embodiment, the bracket 48 is provided at a position of one of the recesses 36.

A link arm 54, serving as an example of a link member, is fixed to a portion where the rotation shaft 40 projects out from the outer tube 34 and the shaft bearing 42 (on the same side as the bracket 48). An anchor portion 56 is formed to the link arm 54. The other end of the return spring 52 is anchored to the anchor portion 56.

The return spring 52 is a tension coil spring that causes a tension force to act on the link arm 54. The tension force of the return spring 52 acts on the rotation shaft 40 through the link arm 54. Part of the tension force (tangential direction component SF-T, described below) acts constantly in a direction to swing the valve member 38 in the closing direction (an arrow T1 direction).

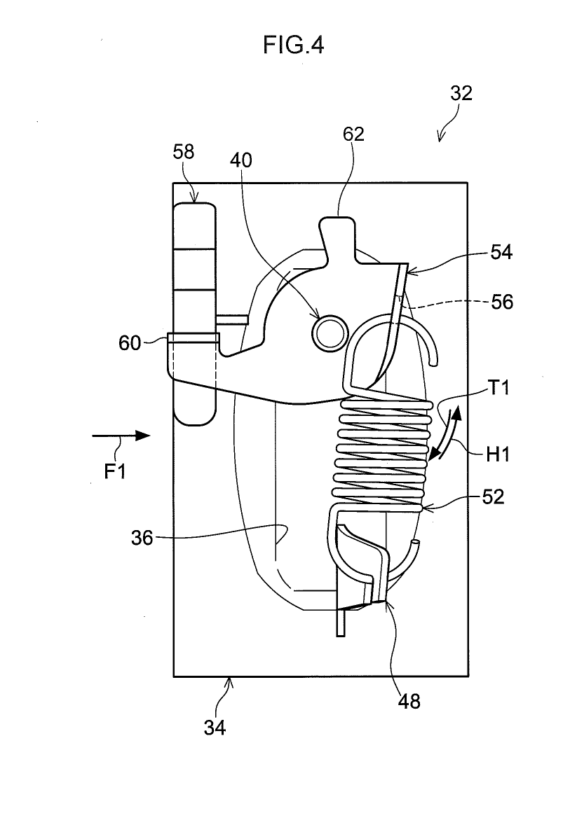

As is apparent from FIG. 4, as viewed from the side of the outer tube 34, the anchor portion 56 is offset further to the downstream side in the exhaust gas flow direction than the rotation shaft 40. The link arm 54 functions as a link that rotates about the rotation shaft 40 to the anchor portion 56 side.

A stopper tab 58 is attached to the outer periphery of the outer tube 34 at the upstream side of the rotation shaft 40. A closing direction stopper projection 60 and an opening direction stopper projection 62 are formed to the link arm 54. The closing direction stopper projection 60 and the opening direction stopper projection 62 respectively project out to the radial direction outside as viewed along the rotation shaft 40.

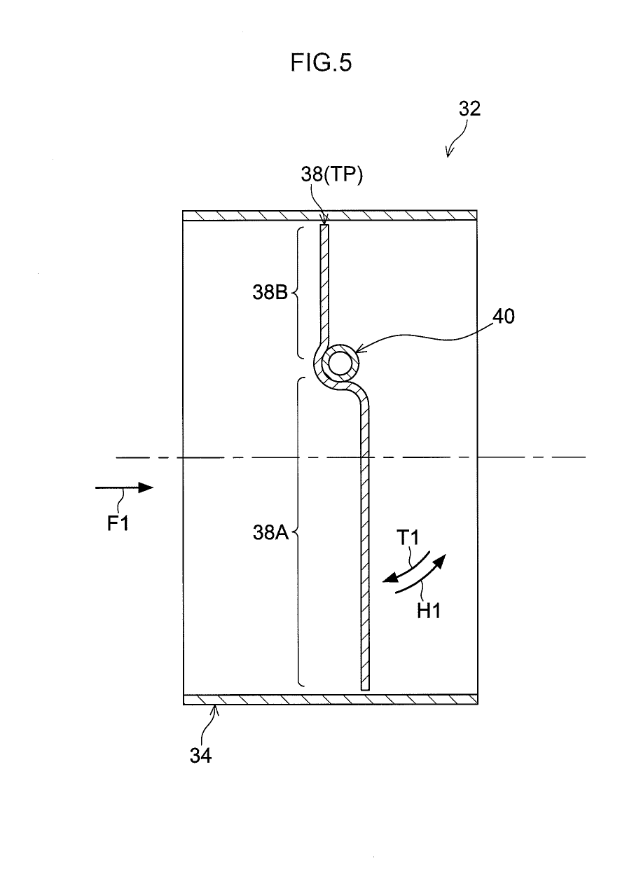

The closing direction stopper projection 60 is formed at a position so as to abut the stopper tab 58 when the valve member 38 attempts to rotate further in the closing direction (the arrow T1 direction) from a closed position TP (see FIG. 5), thereby preventing further rotation in the closing direction.

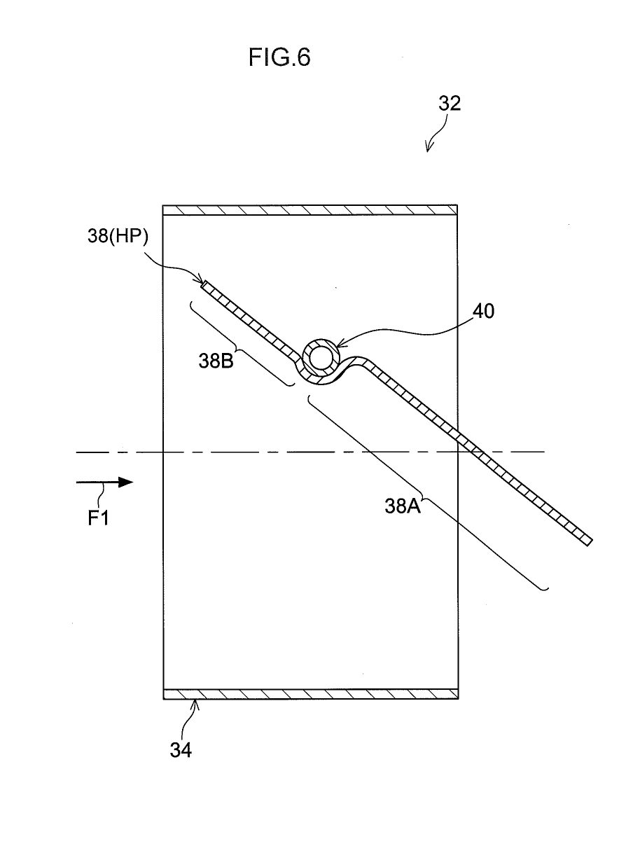

The opening direction stopper projection 62 is formed at a position so as to abut the stopper tab 58 when the valve member 38 attempts to rotate further in the opening direction (the arrow H1 direction) from an open position HP (see FIG. 6), thereby preventing further rotation in the opening direction. Namely, the closing direction stopper projection 60 and the opening direction stopper projection 62 limit the rotation range of the valve member 38 to between the closed position TP and the open position HP.

Explanation next follows regarding operation of the present exemplary embodiment.

In a state in which exhaust gas is not flowing inside the outer tube 34, and in a state in which there is a low flow velocity of exhaust gas, the valve member 38 receives part of the tension force acting from the return spring 52 as a rotation force in the closing direction, and is in the closed position TP, as illustrated in FIG. 5. In this state, as illustrated in FIG. 1 and FIG. 4, the closing direction stopper projection 60 is abutting the stopper tab 58, and so the valve member 38 does not rotate any further in the closing direction, and is maintained in the closed position TP.

When the flow velocity of the exhaust gas inside the outer tube 34 rises, a force from the exhaust gas acts on the valve member 38, acting in the opening direction (the arrow H1 direction) on the large area portion 38A, and acting in the closing direction (the arrow T1 direction) on the small area portion 38B. Due to the surface area of the large area portion 38A being greater than the surface area of the small area portion 38B, the force received from the exhaust gas is also greater, with these forces acting in opposite rotation directions to each other. Part of the rotation force in the opening direction acting on the large area portion 38A is accordingly canceled out by the rotation force in the closing direction acting on the small area portion 38B. As a result a rotation force acts on the valve member 38 in the opening direction. When this rotation force becomes larger than the rotation force from the return spring 52 acting in the closing direction, the valve member 38 rotates in the opening direction.

As illustrated in FIG. 6, when the valve member 38 reaches the open position HP, the opening direction stopper projection 62 abuts the stopper tab 58. The valve member 38 accordingly does not rotate further in the opening direction (the arrow H1 direction).

When the rotation force from the exhaust gas acting in the opening direction becomes less than the rotation force from the return spring 52 acting in the closing direction, the valve member 38 rotates in the closing direction.

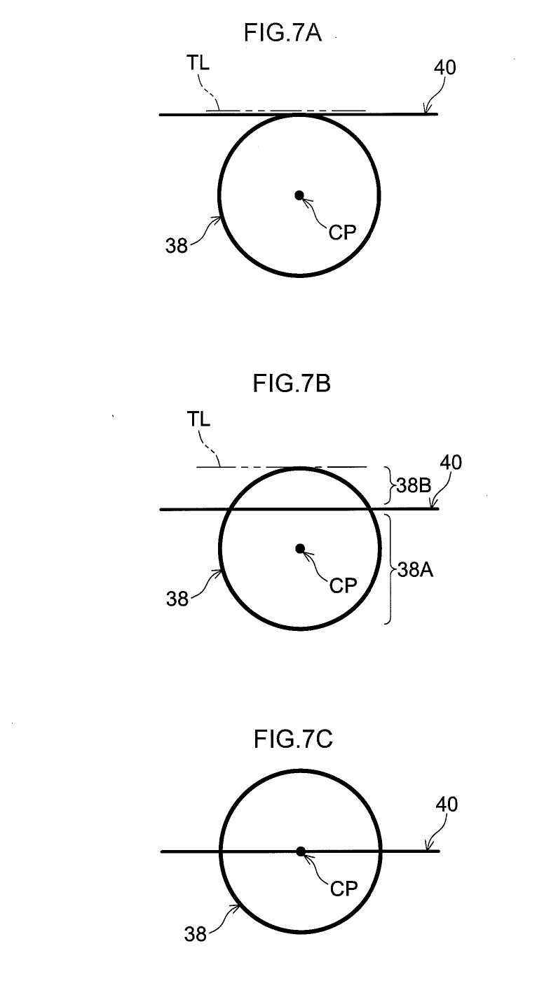

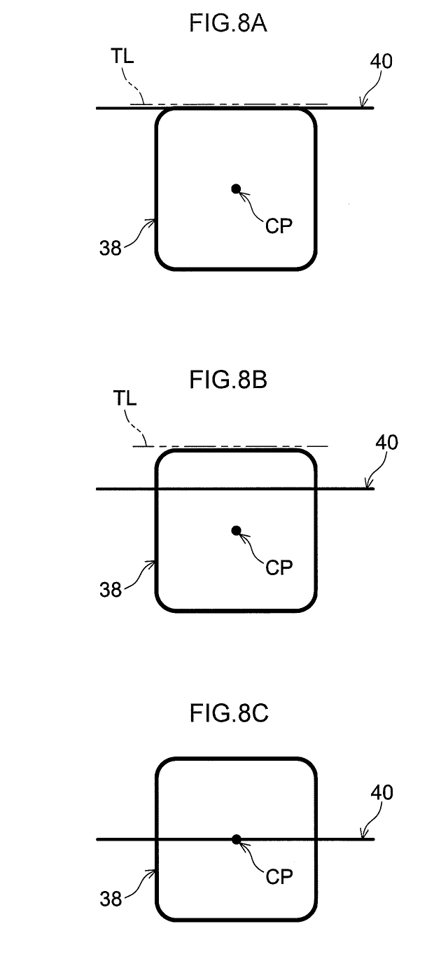

Explanation follows regarding the position of the rotation shaft 40, namely, the center of rotation of the valve member 38, with reference to FIGS. 7A to 7C, and FIGS. 8A to 8C. FIGS. 7A to 7C illustrate a case in which the valve member 38 is a circular shape when viewed face-on, and FIGS. 8A to 8C illustrate cases in which the valve member 38 is a rectangular shape (including a square shape) when viewed face-on, with the shape of the valve member simplified in each case. Explanation follows regarding the structures of FIG. 7A and FIG. 8A, as a first comparative example.

In FIG. 7B and FIG. 8B, similarly to in the above exemplary embodiment, the rotation shaft 40 is provided to the inside of a tangent TL to the outer periphery of the valve member 38, and passing through a position avoiding the center point CP. Adopting such a structure in the present exemplary embodiment may be described as the dividing the valve member into the large area portion 38A and the small area portion 38B using the rotation shaft 40.

In contrast thereto, in FIG. 7A and FIG. 8A, the position of the rotation shaft 40 is aligned with a tangent to the outer periphery of the valve member 38. In the structures of FIG. 7A and FIG. 8A, the valve member is not divided by the rotation shaft 40 into a large area portion and a small area portion (see FIG. 7B and FIG. 8B). In the structures of FIG. 7A and FIG. 8A, all of the force from the exhaust gas acting on the valve member 38 acts as a rotation force toward the opening direction of the valve member 38. Namely, the force acting on the valve member 38 in the opening direction is large. A large force is accordingly required to bias the valve member 38 in the closing direction, and so the tension force of a return spring is set large.

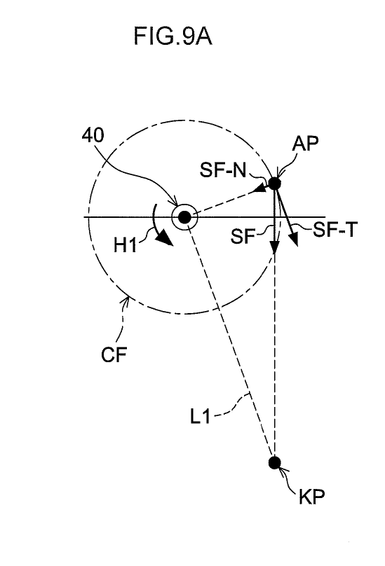

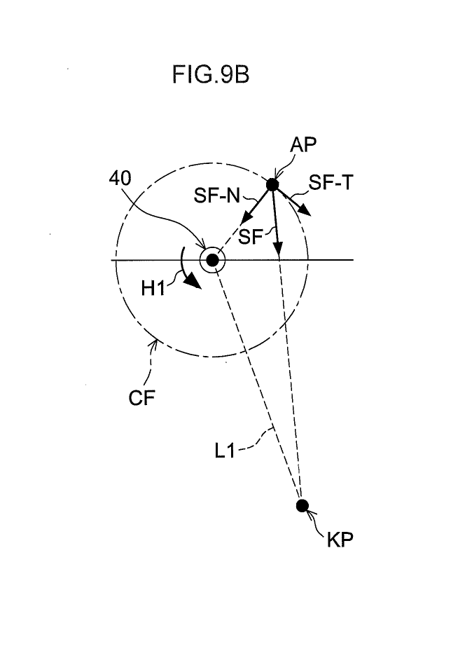

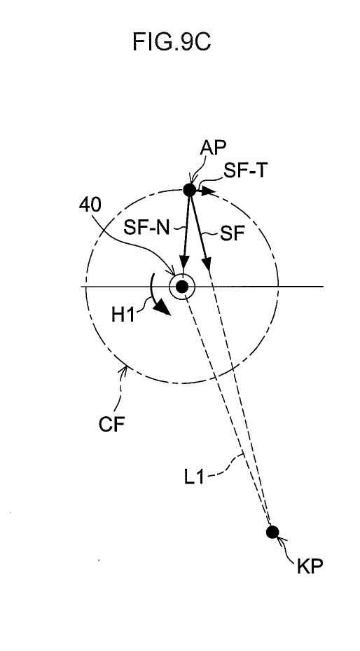

FIG. 9A to FIG. 9C illustrate the relationship between the force from the return spring 52 acting on the link arm 54 and the position of the valve member 38 (the link arm 54). FIG. 9A illustrates a state in which the valve member 38 is in the closed position TP (see FIG. 5), FIG. 9C illustrates a state in which the valve member 38 is in the open position HP (see FIG. 6), and FIG. 9B illustrates a state in which the valve member 38 is partway between the closed position TP and the open position HP.

In FIG. 9A to FIG. 9C, the link arm 54 also rotates accompanying rotation of the valve member 38 (the rotation shaft 40), and so the action point AP moves around a circumference CF. A tangential direction component SF-T of a tension force SF acts on the valve member 38 as a force in the closing direction. A normal direction component SF-N of the tension force SF, however, acts on the contact portions between the rotation shaft 40 and the shaft bearings 42. When the force of the normal direction component SF-N is large, the frictional force between the rotation shaft 40 and the shaft bearings 42 is also large.

As is apparent from FIG. 9A to FIG. 9C, within the rotation range of the valve member 38, the action point AP is always on the same side of a straight line L1 connecting the anchor point KP and the rotation shaft 40 (the center of rotation) together, namely the side on which the tangential direction component SF-T acts as a force in the closing direction.

As is apparent from FIG. 9A, when the valve member 38 is in the closed position, the tangential direction component SF-T of the tension force SF is larger than the normal direction component SF-N. However, as is apparent from FIG. 9B, as the valve member 38 rotates toward the open position, the normal direction component SF-N gradually gets larger, and the tangential direction component SF-T becomes smaller. When, for example, in a state in which the valve member 38 is in the open position, as illustrated in FIG. 9C, the normal direction component SF-N of the tension force SF is larger than the tangential direction component SF-T. Thus in the state in which the normal direction component SF-N is large, the frictional force between the rotation shaft 40 and the shaft bearings 42 is also large.

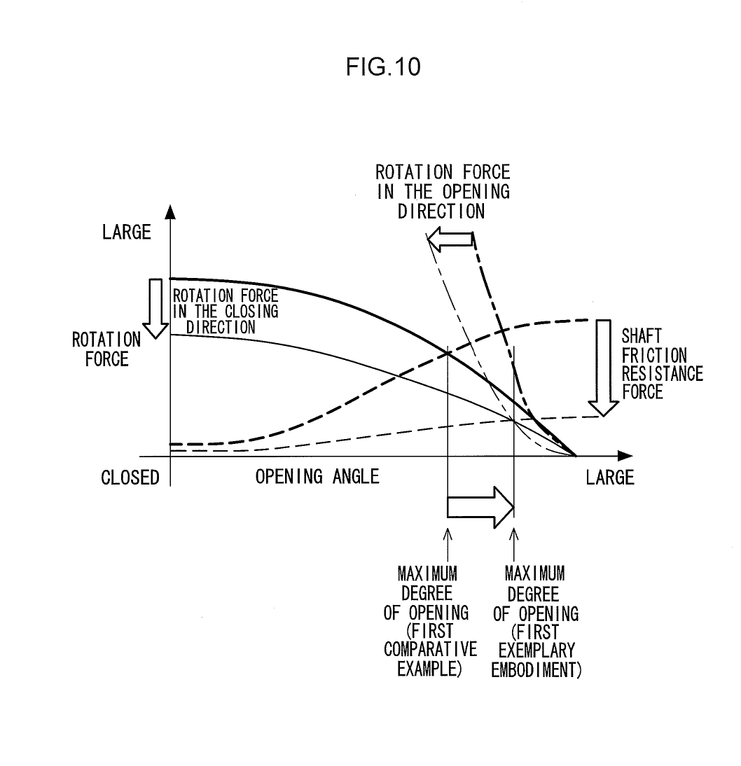

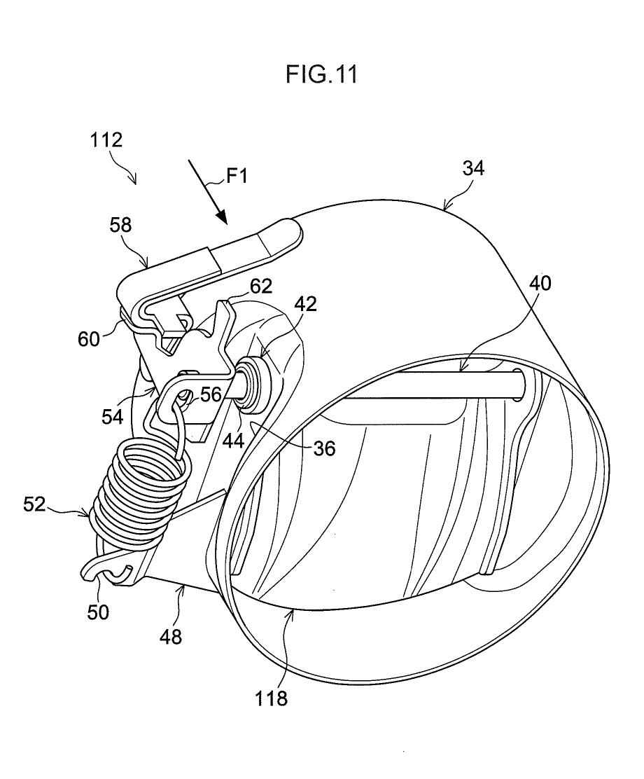

FIG. 10 qualitatively illustrates the frictional force between the rotation shaft 40 and the shaft bearings 42 (shaft friction resistance force), and the rotation force (in the opening direction and the closing direction) acting on the rotation shaft 40, as a function of the opening angle of the valve member 38 in the first exemplary embodiment and the first comparative example. The rotation force in the opening direction is acting from the exhaust gas. The rotation force in the closing direction is acting from the return spring 52. In this graph, the thin lines (solid line, even dashed line, and small-large dashed line) correspond to the first exemplary embodiment, and the bold lines (solid line, even dashed line, and small-large dashed line) correspond to the first comparative example.

As is apparent from the graph, in the first exemplary embodiment, the rotation force acting on the valve member 38 from the exhaust gas in the opening direction is smaller than in the first comparative example. Thus the rotation force acting on the rotation shaft 40 from the return spring 52 in the closing direction is also set smaller in the first exemplary embodiment than in the first comparative example. The “shaft friction resistance force”, namely the frictional force between the rotation shaft 40 and the shaft bearings 42, is also smaller in the exemplary embodiment than in the first comparative example. In order to actually rotate the valve member 38 in the closing direction, the rotation force in the closing direction needs to be larger than the shaft friction resistance force, and the opening angle of the valve member 38 at the intersection of the curves indicating this point is the “maximum degree of opening”. It is apparent that in the first exemplary embodiment, the maximum degree of opening is larger than that of the first comparative example.

Moreover, in the first exemplary embodiment, the return spring 52, as an example of a tension coil spring, is employed as the member to cause rotation force to act on the rotation shaft 40 in the closing direction. In contrast thereto, instead of a tension coil spring, for example, a type of spring that is wound around the rotation shaft 40 (a torsion coil spring) might also be considered. However, if a torsion coil spring is mounted to the rotation shaft 40 with an action point AP (see FIG. 9A to FIG. 9C) set at a position distanced from the rotation shaft 40, the arm portions of the torsion coil spring become long. Flexing and twisting sometimes occurs in the arm portions when the arm portions of the torsion coil spring are made longer, making it difficult to cause tension force to act stably on the rotation shaft.

In the first exemplary embodiment, the tension coil spring is employed as a member to cause rotation force to act on the valve member 38 in the closing direction, and so there is a large degree of freedom for setting the position of the action point AP. It is accordingly possible to position the action point AP at a position a distance away from the rotation shaft 40. Distancing the action point AP from the rotation shaft 40 enables a large rotation force (rotation moment) to act on the rotation shaft 40 in the closing direction, even when the tension force of the return spring 52 is weak. Making the tension force of the return spring 52 weak makes the “maximum degree of opening” of the valve member 38 larger.

As described above, the position of the rotation shaft 40 (the center of rotation) is preferably near to the center point CP from the perspective of making the rotation force in the opening direction from the exhaust acting on the valve member 38 gas smaller. However, if, as illustrated in FIG. 7C and FIG. 8C, the position of the rotation shaft 40 is set so as to pass through the center point CP, the surface areas of the two portions divided by the rotation shaft 40 are equivalent to each other. The forces acting from the exhaust gas on the valve member 38 cancel each other out in these two portions so as to become zero (so as not to act in either the opening direction or the closing direction), making it difficult to rotate the valve member 38 in the opening direction. In the first exemplary embodiment, the rotation shaft 40 (center of rotation) avoids the center point CP, giving rise to the large area portion 38A and the small area portion 38B. This thereby enables the valve member 38 to be reliably rotated in the opening direction under the action of force from the exhaust gas.

Explanation follows regarding a second exemplary embodiment. In the second exemplary embodiment, elements, members, etc. that are the same as those of the first exemplary embodiment are allocated the same reference numerals, and detailed explanation will be omitted thereof.

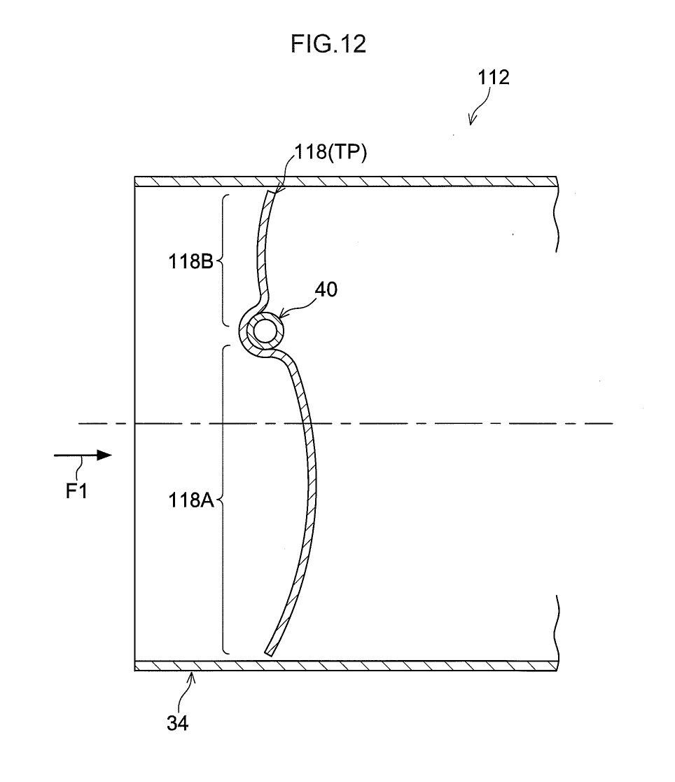

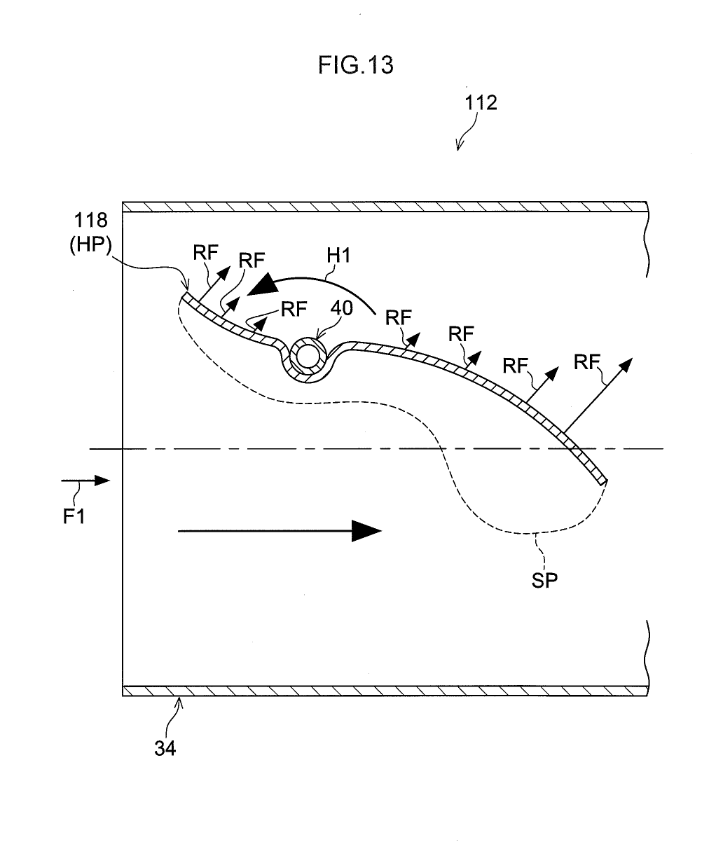

In a valve structure 112 of the second exemplary embodiment, the structure of the valve member differs from that of the first exemplary embodiment. Namely, as illustrated in FIG. 12 and FIG. 13, in a valve member 118 of the second exemplary embodiment, a large area portion 118A (pressure bearing face) is curved as viewed in cross-section taken along the flow direction of exhaust gas, so as to form a bulging shape toward the flow direction downstream side. The second exemplary embodiment, as is apparent from FIG. 11, has a structure the same as that of the first exemplary embodiment except for in the shape of the valve member.

In the example illustrated in FIG. 12, a small area portion 118B is curved so as to form a bulging shape toward the flow direction upstream side, however the shape of the small area portion 118B is not particularly limited.

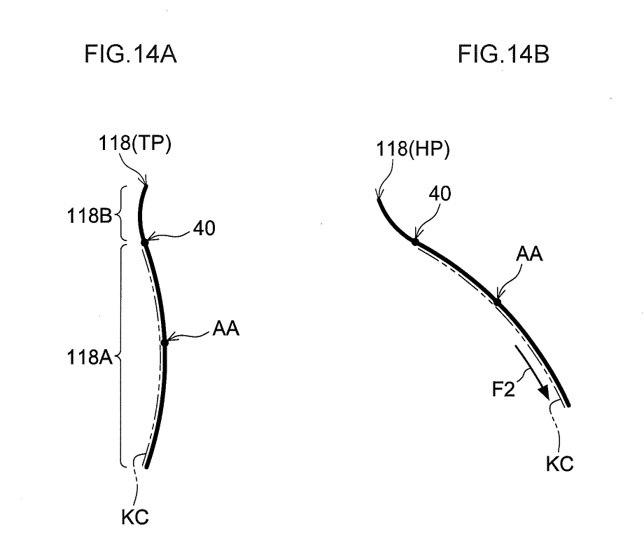

FIG. 14A and FIG. 14B schematically illustrate the shape of the valve member 118 of the second exemplary embodiment, in a cross-section of the valve member 118 taken along the flow direction. In the cross-section, the curvature of the large area portion 118A of the second exemplary embodiment is constant irrespective of the distance from the rotation shaft 40 (the center of rotation). In other words, the shape of the large area portion 118A illustrated in FIG. 12, FIG. 13, FIG. 14A, and FIG. 14B is part of a circle.

In the valve structure 112 of the second exemplary embodiment, in a state in which exhaust gas is not flowing inside the outer tube 34 and a state in which the flow velocity of exhaust gas is low, the valve member 118 does not rotate in the opening direction or the closing direction, and is maintained in the closed position TP.

In the second exemplary embodiment, the large area portion 118A (pressure bearing face) has a bulging shape toward the downstream side in the flow direction of the exhaust gas. Thus, as illustrated in FIG. 13, when the valve member 118 is in the open position HP (or when it is between the closed position TP and the open position HP), a surface pressure SP of the valve member 118 generated by flow of the exhaust gas tends to be larger the further away from the rotation shaft 40. The rotation force acting on the valve member 118 in the opening direction is accordingly also larger, and so the opening angle of the valve member 118 is larger.

Specifically, in the second exemplary embodiment, the curvature of the large area portion 118A of the valve member 118 is constant irrespective of the distance from the rotation shaft 40 (the center of rotation). In other words, in the second exemplary embodiment, as illustrated in FIG. 14A and FIG. 14B, when an imaginary circle KC with the same curvature as the curvature of the large area portion 118A is envisaged at a freely selected point AA within the large area portion 118A, then the imaginary circle KC matches the large area portion 118A.

In the second exemplary embodiment, as illustrated in FIG. 14B, when the valve member 118 is in the open position HP, the exhaust gas hitting the large area portion 118A at a point AA moves toward the downstream side along the large area portion 118A, as illustrated by arrow F2. The large area portion 118A is positioned along the flow F2 of the exhaust gas. Due to the flow F2 of exhaust gas not breaking away from the large area portion 118A, negative pressure is suppressed from being generated at the large area portion 118A.

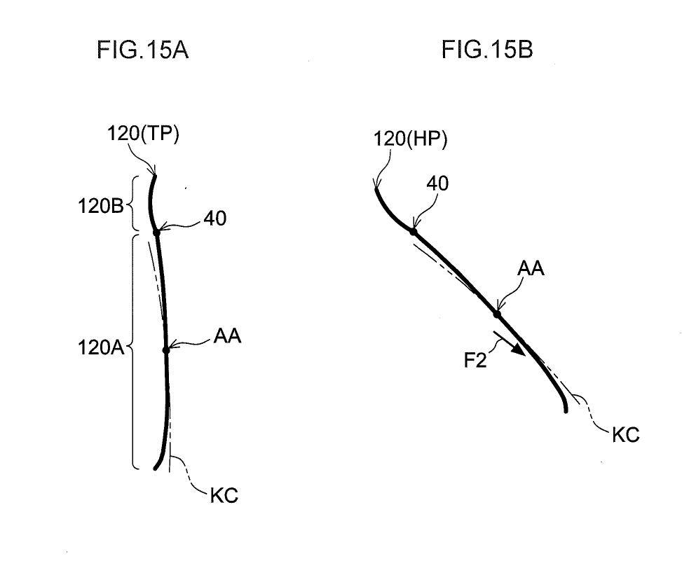

A valve member 120 of a first modified example of the second exemplary embodiment may be employed as a valve member, as illustrated in FIG. 15A and FIG. 15B. The valve member 120 is divided into a large area portion 120A and a small area portion 120B, and the curvature of the large area portion 120A is shaped to be greater further away from the rotation shaft 40 (center of rotation).

In the structure illustrated in FIG. 15A and FIG. 15B, the large area portion 120A is further to the upstream side in the exhaust gas flow direction than the imaginary circle KC at positions further away than the point AA, as viewed from the rotation shaft 40. As illustrated in FIG. 15B, when the valve member 120 is in the open position HP, the exhaust gas hitting the large area portion 120A at the point AA moves along the large area portion 120A toward the downstream side, as illustrated by arrow F2. A pressing force acts on the large area portion 120A in the opening direction (toward the downstream side) due to the flow F2 of the exhaust gas. Namely, likewise with the structure illustrated in FIG. 15A and FIG. 15B, negative pressure is suppressed from being generated at the large area portion 120A.

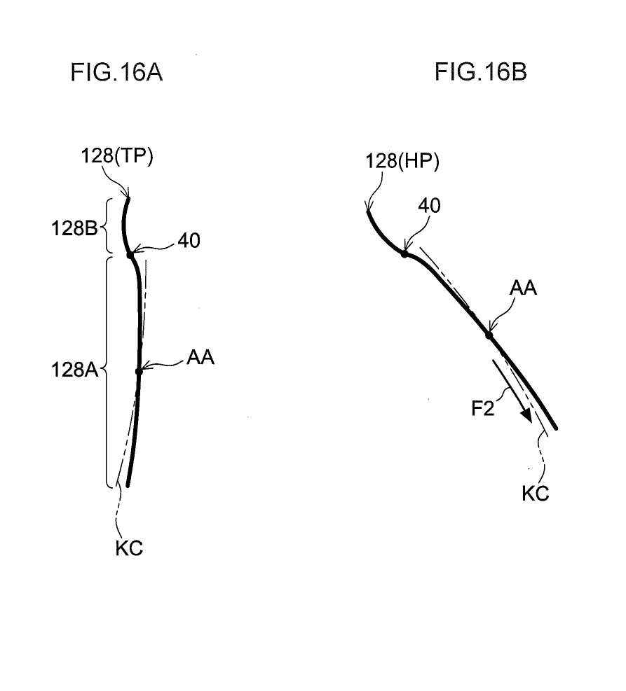

Consider, as a second modified example of the second exemplary embodiment, as illustrated in FIG. 16A and FIG. 16B, a configuration in which a valve member 128 is divided into a large area portion 128A and a small area portion 128B, and the curvature of the large area portion 128A becomes less (including cases in which the curvature becomes zero, and cases in which the curvature becomes negative) on moving away from the rotation shaft 40 (center of rotation).

In the second modified example, when the imaginary circle KC is envisaged at a freely selected point AA of the large area portion 128A, then the large area portion 128A is positioned further to the downstream side than the imaginary circle KC at positions further from the rotation shaft 40 than point AA. In such a structure, as illustrated in FIG. 16B, there is a concern that negative pressure might be generated at the large area portion 128A when a portion arises of the exhaust gas flow F2 that has hit the large area portion 128A in a direction moving away from the large area portion 128A. Such negative pressure acts as a rotation force on the valve member 128 in the closing direction.

Although the structure of the second modified example is also included in the present invention, generation of negative pressure that acts as a rotation force on the valve member 118, 120 in the closing direction can be particularly suppressed from being generated in the second exemplary embodiment and the first modified example when the valve member 118, 120 is in the open position HP. This thereby makes the opening angle of the valve member 118, 120 large.

Explanation next follows regarding a third exemplary embodiment. The same reference numerals are appended in the third exemplary embodiment to elements and members the same as those of the first exemplary embodiment and the second exemplary embodiment, and detailed explanation thereof will be omitted.

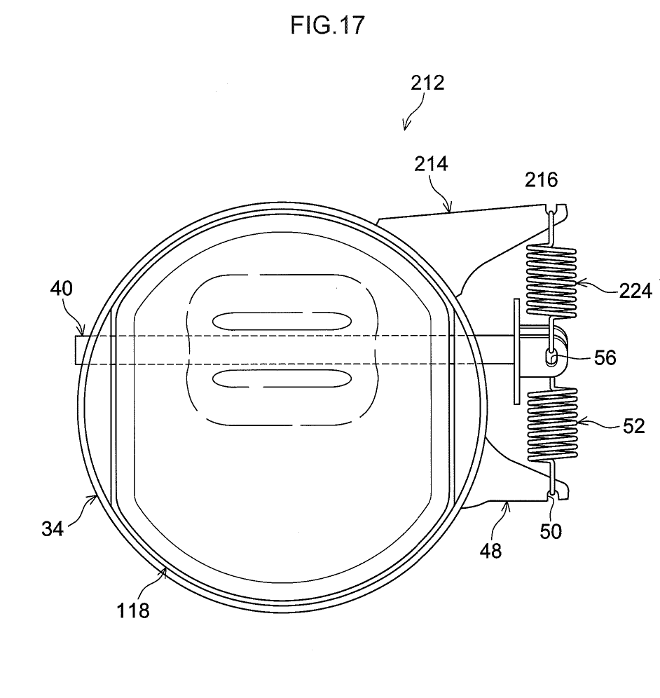

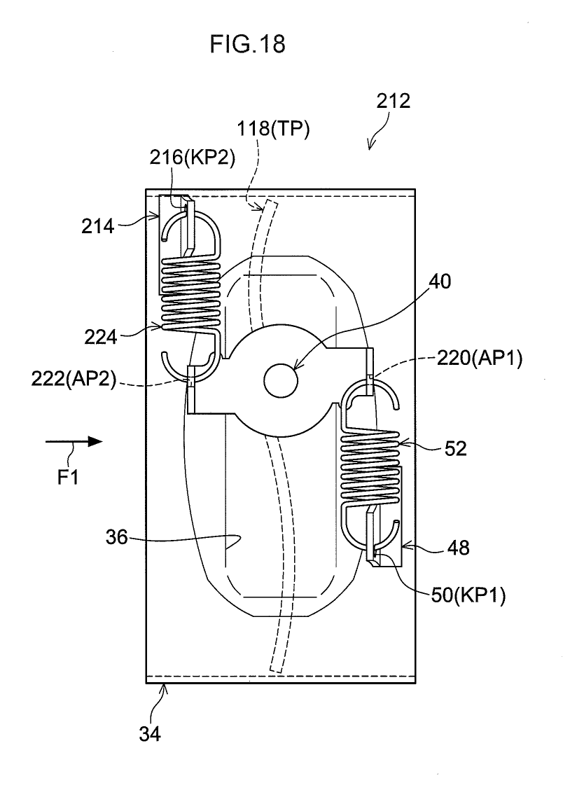

A valve structure 212 of the third exemplary embodiment includes, as illustrated in FIG. 17 and FIG. 18, a bracket 214 in addition to the bracket 48 of the first exemplary embodiment or the second exemplary embodiment.

The bracket 214 includes an anchor portion 216. The position of the anchor portion 216 (an anchor point KP2) has point symmetry centered on the rotation shaft 40 to the position of the anchor portion 50 (an anchor point KP1) in a side view of the outer tube 34, as illustrated in FIG. 18.

A link arm 218 of the third exemplary embodiment includes two anchor portions 220, 222. The anchor portion 220 (an action point AP1) and the anchor portion 222 (an action point AP2) are positioned with point symmetry to each other, centered on the rotation shaft 40.

The third exemplary embodiment includes a return spring 224 in addition to the return spring 52. One end of the return spring 52 is anchored to the anchor portion 50, and the other end thereof is anchored to the anchor portion 220. One end of the return spring 224 is anchored to the anchor portion 216, and the other end thereof is anchored to the anchor portion 222. The two return springs 52, 224 accordingly cause tension forces SF, TF to act in directions with point symmetry with respect to the link arm 218, at positions with point symmetry centered on the rotation shaft 40.

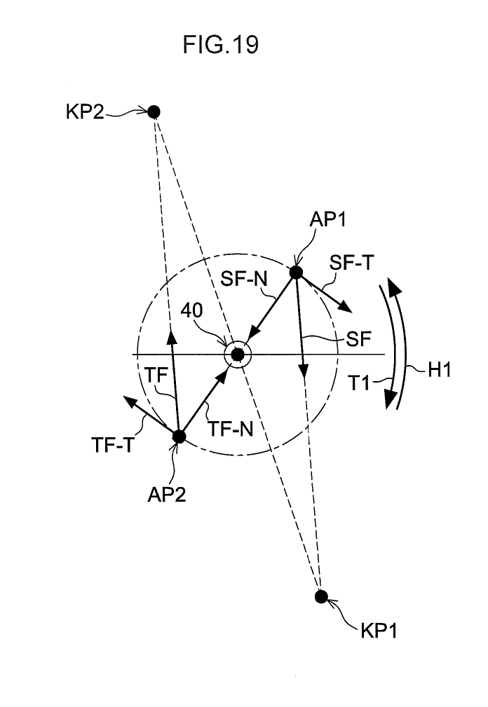

FIG. 19 illustrates the tension forces SF, TF acting from the return springs 52, 224 on the link arm 218 in the open position state of the valve member 118 of the third exemplary embodiment. In the third exemplary embodiment, the tension force SF acting from the return spring 52 and the tension force TF acting from the return spring 224 have a point symmetry relationship with respect to the link arm 218. The tangential direction component SF-T of the tension force SF acting from the return spring 52 and the tangential direction component TF-T of the tension force TF acting from the return spring 224 both work in the closing direction of the valve member 118 (the arrow T1 direction). Thus the force acting in the closing direction of the valve member 118 is larger than in the first exemplary embodiment and the second exemplary embodiment.

However, a normal direction component SF-N of the tension force SF acting from the return spring 52 and of a normal direction component TF-N of the tension force TF acting from the return spring 224 have the same magnitude as each other, and act in opposing directions so as to cancel each other out. Thus there is no effective force from the return springs 52, 224 acting at the contact portions between the rotation shaft 40 and the shaft bearings 42 (or only a small force even if one acts), and frictional force between the rotation shaft 40 and the shaft bearings 42 is also small.

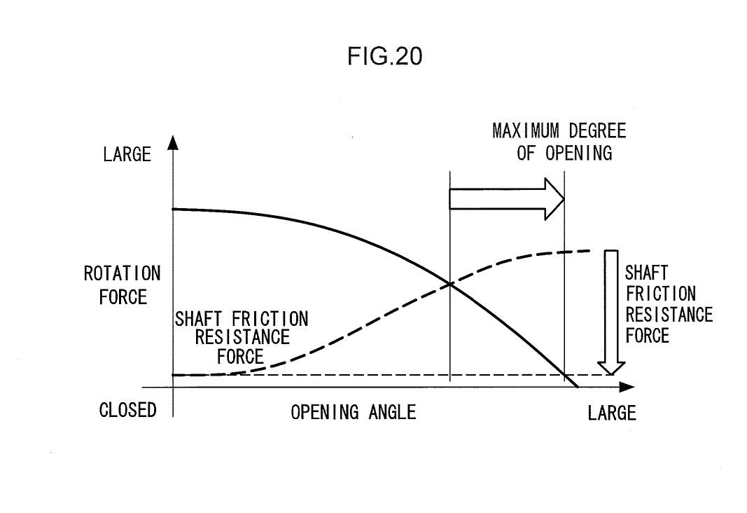

FIG. 20 qualitatively illustrates the frictional force between the rotation shaft 40 and the shaft bearings 42 (shaft friction resistance force), and the rotation force in the closing direction acting on the rotation shaft 40, as a function of the opening angle of the valve member 38 in the third exemplary embodiment.

In the third exemplary embodiment, as described above, since there is no effective force from the return springs 52, 224 acting at the contact portions between the rotation shaft 40 and the shaft bearings 42, the frictional force between the rotation shaft 40 and the shaft bearings 42 is small, and is constant irrespective of the opening angle. The maximum degree of opening of the third exemplary embodiment is accordingly a larger maximum degree of opening than the maximum degree of opening of the first exemplary embodiment and the maximum degree of opening of the second exemplary embodiment.

In the third exemplary embodiment, in the above example, the two return springs 52, 224 can be said to have a rotational symmetry relationship that is two-fold rotational symmetry about the rotation shaft 40. In the third exemplary embodiment N return springs may be provided at positions so as to give N-fold rotational symmetry, wherein N is an integer of two or more. For example, if N=3, then this would be a configuration in which three return springs are provided at rotation symmetrical positions, at positions having center angles of 120°.

In the first exemplary embodiment to the third exemplary embodiment, the pair of recess 36 are formed to the outer tube 34, and the shaft bearings 42 are provided in the recesses 36. Namely, the recesses 36 act as the seating faces of the shaft bearings 42. This thereby enables a structure to be implemented with high surface rigidity of the seating face portions of the shaft bearings 42. The high surface rigidity of the seating face portions of the shaft bearings 42 suppresses flexing from occurring in the outer tube 34 due to force acting on the outer tube 34 from the shaft bearings 42. Misalignment between the center lines of the shaft bearings 42 and the rotation shaft 40 is thereby suppressed, suppressing the frictional force between the shaft bearings 42 and the rotation shaft 40 from increasing, and enabling a larger maximum degree of opening of the valve member 38, 118.

As explained above, a large opening of the valve member 38, 118 is possible in the valve structures of the first exemplary embodiment to the third exemplary embodiment, enabling a wide cross-sectional area to be secured for exhaust gas to pass through. Therefore, for example, even when an engine is operating at high revolutions, the pressure loss in the valve member 38 is small, enabling implementation of the valve structure 32 with a high back pressure reduction effect.

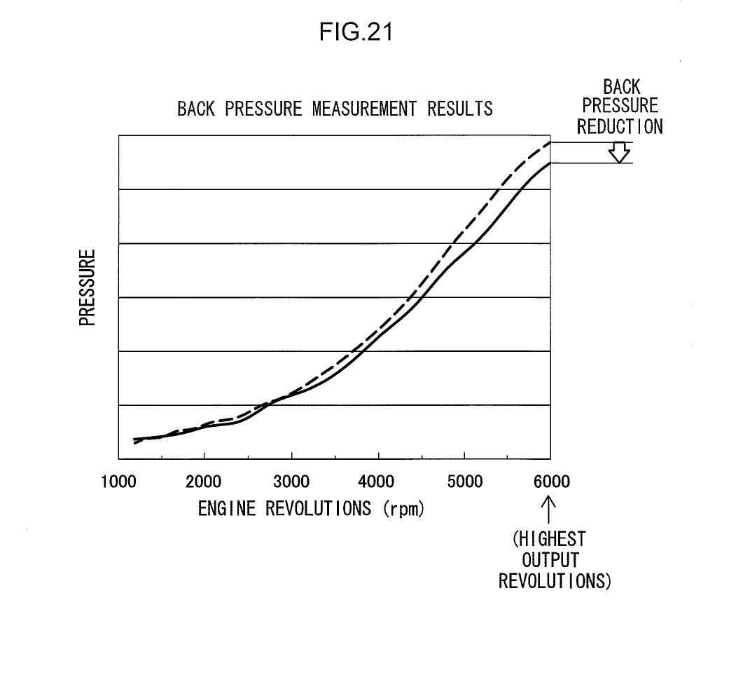

As an example, FIG. 21 qualitatively illustrates relationships between engine revolutions and back pressure for the second exemplary embodiment and the first comparative example. In the graphs of FIG. 21 to FIG. 23, the solid line corresponds to the second exemplary embodiment, and the dashed line corresponds to the first comparative example.

As can be seen from FIG. 21, the second exemplary embodiment achieves a higher back pressure reduction effect than the first comparative example, particularly in a high revolution range (400 rpm or greater).

In the valve structures of the first exemplary embodiment to the third exemplary embodiment, the large opening of the valve member 38 enables noise arising from exhaust gas hitting the valve member 38 to be reduced.

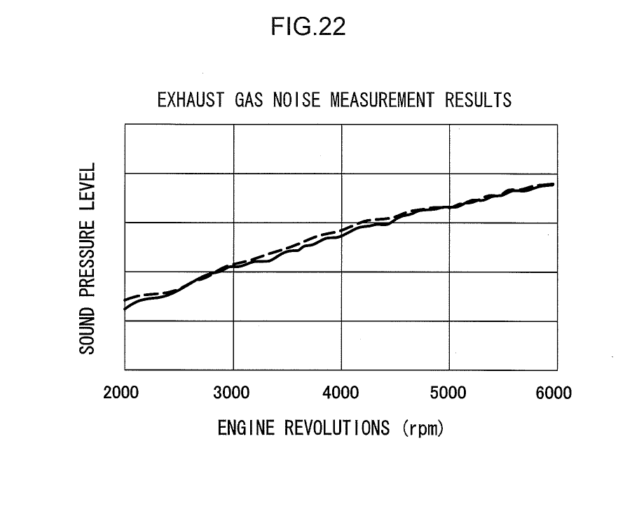

As an example, FIG. 22 qualitatively illustrates relationships between engine revolutions and exhaust noise sound pressure level in the second exemplary embodiment and the first comparative example. It is apparent that the second exemplary embodiment has, in particular, a higher noise suppressing effect than that of the first comparative example. Specifically, in the second exemplary embodiment, the sound pressure level is lower than that of the first comparative example, in a range of engine revolutions of from 3000 to 5000 rpm.

Moreover, in the valve structure of the first exemplary embodiment to the third exemplary embodiment, the large opening of the valve member 38 enables resonation noise arising from the return spring 52 (or the return springs 52, 224) and exhaust gas acting on the valve member 38, 118 to be suppressed.

In a system that vibrates with one degree of freedom, generally a vibration frequency f is given by the following equation, wherein the spring constant of a spring causing the tension force in the system is k, and the inertial moment of the system is I.

$$f = \frac{1}{2 π} \sqrt{\frac{k}{I}} \qquad ( 1 )$$

I is related by the following equation to the mass m of the system, and a distance L from the center of rotation (the rotation shaft 40) to the center of mass.

$$I = \frac{1}{2} m {L}^{2} \qquad ( 2 )$$

For example, it is apparent from Equation (2) that as the mass m increases, the inertial moment I of the system also gets larger. It is apparent from Equation (1) that when the inertial moment I increases, the vibration frequency f decreases. However, a larger mass m also leads to an increase in mass of the valve structure.

In contrast, in the first exemplary embodiment to the third exemplary embodiment, the springs with small tension force can be employed as the return springs 52, 224, with this leading to a small spring constant k in Equation (1). The mass m of the valve members 38, 118 is not large in the first exemplary embodiment to the third exemplary embodiment, so this does not lead to an increase in mass of the valve structures 32, 112, 212.

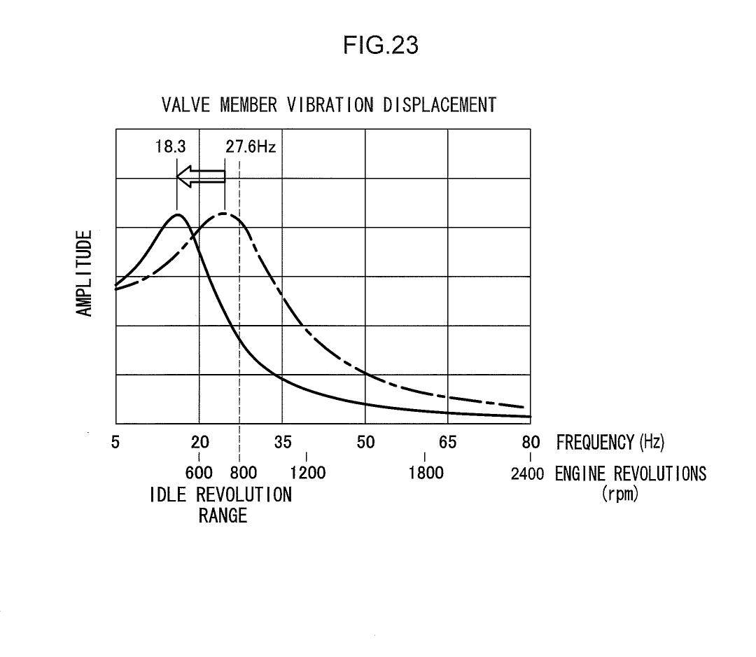

FIG. 23 qualitatively illustrates relationships between engine revolutions and valve member amplitude in the second exemplary embodiment and the first comparative example. Whereas the vibration frequency at the maximum amplitude value in the first comparative example is 27.6 Hz, the vibration frequency is lowered in the second exemplary embodiment to 18.3 Hz. The amplitude at 600 to 800 rpm, an example of the revolutions during engine idling, is smaller in the second exemplary embodiment than in the first comparative example. The second exemplary embodiment accordingly has a higher resonation noise suppressing effect due to the small amplitude of the valve member 38 in engine idling range.

In the present application, biasing force of a biasing member biasing the valve member in closing direction is lowered, reducing friction between the rotation shaft and the shaft bearings, and enabling a large opening angle of the valve member to be secured.

The entire content of the disclosure of Japanese Patent Application No. 2014-208041 filed on 9 Oct. 2014 is incorporated by reference in the present application.

All cited documents, patent applications and technical standards mentioned in the present specification are incorporated by reference in the present specification to the same extent as if the individual cited documents, patent applications and technical standards were specifically and individually incorporated by reference in the present specification.

What is claimed is:

1. A valve structure comprising:
a valve member that is provided at an exhaust pipe, and that rotates from a closed position closing off the exhaust pipe to an open position opening the exhaust pipe upon being contacted by exhaust gas;
a rotation shaft that is fixed to the valve member at a position, when viewing the valve member along an exhaust gas flow direction, inside a tangent to an outer periphery of the valve member and avoiding a center point of the valve member, and that is attached to the exhaust pipe so as to be capable of rotating;
a link member that is fixed to the rotation shaft and includes an action point at a position distanced from the rotation shaft in the flow direction; and
a tension spring that is provided at the exhaust pipe, and that causes tension force to constantly act on the action point to generate a rotation force toward a closing direction of the valve member.

2. The valve structure of claim 1, wherein a pressure bearing face including the center point of the valve member has a shape bulging toward a downstream side in the flow direction.

3. The valve structure of claim 2, wherein a curvature of the pressure bearing face, as viewed in cross-section taken along the flow direction, increases as a distance from the rotation shaft increases, or is constant.

4. The valve structure of claim 1, further comprising an outer tube that configures a portion of the exhaust pipe and to which the rotation shaft is attached.

5. The valve structure of claim 4, further comprising a recess indented toward an inner side at a portion of the outer tube where the rotation shaft is attached.

6. The valve structure of claim 4, further comprising:
a stopper tab provided at the outer tube;
a closing direction stopper projection that is provided at the link member, and that contacts the stopper tab and prevents rotation toward the closing direction when the valve member attempts to rotate from the closed position further in the closing direction; and
an opening direction stopper projection that is provided at the link member, and that contacts the stopper tab and prevents rotation toward an opening direction when the valve member attempts to rotate from the open position further in the opening direction.

7. The valve structure of claim 1, wherein there are two of the action points provided at positions having point symmetry to each other about a center of the rotation shaft.
